(19) United States
(12) Patent Application Publication
(10) Pub. No.: US 2025/0254728 A1
(43) Pub. Date: Aug. 7, 2025

(54) METHOD FOR OPERATING A NETWORK OF AMBIENT (IoT) DEVICES

(71) Applicant: Wiliot, Ltd., Caesarea (IL)

(72) Inventors: Solomon TRAININ, Haifa (IL); Amichai SANDEROVICH, Atlit (IL); Penny EFRAIM-SAGI, Kfar Sava (IL); David LIPSHITZ, Raanana (IL); Alon YEHEZKELY, Haifa (IL)

(73) Assignee: Wiliot, Ltd., Caesarea (IL)

(21) Appl. No.: 19/046,971

(22) Filed: Feb. 6, 2025

Related U.S. Application Data
(60) Provisional application No. 63/550,900, filed on Feb. 7, 2024.

(51) Int. Cl. H04W 74/0816; H04W 24/02; H04W 24/08

(52) U.S. Cl. CPC H04W 74/0816; H04W 24/02; H04W 24/08

(57) ABSTRACT

A method and system for operating a network of ambient Internet of Things (IoT) devices are disclosed. The method includes generating radio frequency (RF) pulses by at least one ambient-B device; accumulating energy harvested from the RF pulses at one or more ambient IoT devices, wherein the one or more ambient IoT devices transition from a no-energy state to an active high-energy state upon reaching a sufficient level of accumulated energy; continuously monitoring a serving channel and a backoff counter by the at least one ambient-B device to determine clear channel conditions; triggering transmission frames by the at least one ambient-B device when the backoff counter reaches zero; and transmitting data from one or more ambient IoT devices to the at least one ambient-B device over a serving RF channel, wherein monitoring and controlled triggering enhance network efficiency and compliance with communication protocols.

### CROSS-REFERENCE TO RELATED APPLICATIONS

This application claims the benefit of U.S. Provisional Application No. 63/550,900 filed on Feb. 7, 2024, the contents of which are hereby incorporated by reference.

### TECHNICAL FIELD

The present disclosed subject matter relates to Internet of Things (IoT) devices. More particularly, the present disclosed subject matter relates to energy-efficient communication for ambient IoT devices using RF energy harvesting.

### BACKGROUND

Radio frequency (RF) signal energy collection and storage are established methods currently implemented in devices designed to harness this energy for communication tasks, including receiving and transmitting data. The ambient IoT system leverages these methods to power devices that lack traditional energy sources. This system comprises two types of devices: one that generates RF energy (ambient-B) and another (the ambient-device) that uses this energy solely for its operation. The former also plays a crucial role in relaying information from the ambient-device to broader networks such as wireless LAN, Third Generation Partnership Project (3GPP) core networks, Bluetooth, or other links as defined by the ambient IoT Alliance.

Ambient IoT devices uniquely depend on harvested energy, presenting notable challenges in energy management. These devices must judiciously manage their stored energy to perform critical functions like data transmission without exhausting their limited reserves. They operate in various energy states, typically remaining dormant to accumulate energy, then activate for communication when sufficient energy has been stored. Ensuring these devices meet operational standards, as stipulated by entities like the IEEE 802.11 WLAN Standard Working Group and the 3GPP, is essential for their reliable functionality within prescribed energy usage and communication parameters.

An ambient-device is a type of IoT technology that functions autonomously by harvesting environmental energy, especially from RF signals. These devices are crucial for operations where traditional power sources like batteries or direct electrical connections are impractical. Ambient-devices are characterized by their ability to manage the energy they harvest and operate in different power states. They are commonly used for wireless communication tasks, enabled by the energy they gather.

Ambient-devices, such as RFID tags in retail and logistics, operate without batteries by harvesting RF energy from nearby readers. Similarly, wireless sensor nodes in agriculture or urban infrastructure, smart home devices like thermostats, and wearable health monitors can also function as ambient-devices by drawing power from environmental RF fields or converting body heat and movement into energy. These applications highlight the versatility and increasing significance of ambient-devices across various sectors.

FIG. 1 shows a timeline diagram 100 of the energy states in an ambient-device's operation. The diagram visually represents the operation of a commercially available ambient-device through different energy states over time, illustrating the dynamic management of energy in response to availability and consumption requirements.

Timeline diagram 100 outlines the cyclical energy routine of a commercially available ambient-device, showing how it adapts its operational states based on available energy. The diagram also depicts the transitions between active and non-active states, detailing the device's energy routine necessary for functioning in an energy-constrained IoT environment.

Energy supply 110 indicates periods when the ambient-device is receiving an energy supply. The continuity of the energy supply 110 line illustrates intermittent energy availability, which is critical for the device to maintain its operational states.

Ambient-device state 120 identifies the periods when the ambient-device can be in one of the following states: no-energy, active-high, or active-low. In the example of timeline diagram 100, the ambient-device is in the no-energy state from periods 1 to 4 and beyond period 11. During these times, the ambient-device is incapable of any operation other than trying to accumulate any available energy, highlighting the device's dependency on external energy to become functional.

In the same example, the ambient-device is in the active-high state from periods 4 to 5 and 9 to 10. This state occurs when the energy level is sufficient for the device to engage in high-energy activities, such as receiving and transmitting data (RX/TX), representing the peak functional capacity of the device. Additionally, the ambient-device enters the active-low state from periods 6 to 9 and 10 to 11. Following the consumption of energy in high-energy activities, this state helps conserve energy while maintaining essential functions like memory retention, crucial for sustained operation under limited energy conditions.

Ambient-Device Activity 130 marks the times when the ambient-device conducts communication tasks during active-high periods. During these intervals, the ambient-device expends its stored energy on essential receiving and transmitting operations (RX/TX), which are crucial for its function within the IoT network.

Ambient-device energy 140 displays how energy is accumulated and depleted within the ambient-device. In timeline diagram 100, the fluctuation of energy levels is evident, with increases during energy accumulation phases and decreases when energy is utilized. The initial stages of energy build-up, represented by Periods 1, 2, and 3, see the device charging up from a no-energy state to an active-high state, readying it for operational tasks. By Period 4, the device reaches full operational capacity, actively engaged in receiving and transmitting data (RX/TX).

By Period 5, the RX/TX activities conclude, leading to a significant drop in energy levels and shifting the device to an active-low state. This low-energy state persists through Periods 6 to 9 as the device once again accumulates energy, preparing for the next RX/TX cycle. The sequence ends at Period 11, where the timeline shows the ambient-device falling back to a no-energy state, highlighting the continuous challenge of sustaining enough energy for uninterrupted operation.

In view of the above, the need for innovative energy management strategies in the IoT landscape is underscored, emphasizing autonomous operations that optimize the use of harvested RF energy.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that, in operation, causes or causes the system to perform the actions. One or more computer programs can be configured to perform particular operations or actions by virtue of including instructions that, when executed by a data processing apparatus, cause the apparatus to perform the actions.

In one general aspect, the method may include generating radio frequency (RF) pulses by at least one ambient-B device. The method may also include accumulating energy harvested from the RF pulses at one or more ambient IoT devices, where the one or more ambient IoT devices transition from a no-energy state to an active high-energy state upon reaching a sufficient level of accumulated energy. The method may furthermore include continuously monitoring a serving channel and a backoff counter by the at least one Ambient-B device to determine clear channel conditions.

The method may, in addition, include triggering transmission frames by at least one ambient-B device when the backoff counter reaches zero. The method may moreover include transmitting data from one or more ambient IoT devices to the at least one ambient-B device over a serving RF channel, where monitoring and controlled triggering enhance network efficiency and compliance with communication protocols. Other embodiments of this aspect include corresponding computer systems, apparatus, and computer programs recorded on one or more computer storage devices, each configured to perform the actions of the methods.

Implementations may include one or more of the following features. The method where the radio frequency (RF) pulses are generated within a frequency band below 1 GHz. The method where the energy harvested from the RF is stored until it reaches a threshold level sufficient for enabling transmission and/or reception, ensuring the ambient IoT devices maintain operational readiness for communication tasks.

The method where the ambient IoT devices accumulate energy from the RF pulses until a sufficient level is reached to transition from a no-energy state to an active high-energy state, thereby managing the timing of their operational readiness based on energy availability. The method where at least one Ambient-B device continuously monitors the serving channel and the backoff counter to determine clear channel conditions before triggering transmission frames.

The method where the transmission frames are triggered by the at least one Ambient-B device only when the backoff counter reaches zero, indicating clear channel conditions for safe transmissions.

The method where the data is transmitted from the one or more ambient IoT devices to the at least one Ambient-B device over the serving RF channel is used for maintaining a communication process within the network.

The method where Listen Before Talk (LBT) protocols implemented by the Ambient-B device ensure transmissions occur only when permissible, thereby maintaining adherence to critical communication standards and avoiding potential interference. The method where data transmission from the ambient IoT devices to the Ambient-B device occurs over a serving RF channel that includes one of a 2.4 GHz band or another spectrum below 1 GHz, ensuring compliant and effective communication.

The method where the Ambient-B device monitors the success of the transmission and adapts energy pulse and transmission frame issuance based on feedback from the ambient IoT devices to improve network reliability and efficiency.

The method where the transmission frames from at least one ambient-B device and the one or more ambient IoT devices are configured to communicate over a Wi-Fi network.

The method where the transmission frames from at least one ambient-B device and the one or more ambient IoT devices are configured to operate within the Third Generation Partnership Project (3GPP) network, adhering to 3GPP communication protocols.

The method where the transmission frames from at least one ambient-B device and the one or more ambient IoT devices are configured to operate over Bluetooth technologies for communication.

The method where the at least one ambient-B device transmits a trigger frame after verifying clear channel access and determining that a sufficient level of energy has been accumulated in the one or more ambient IoT devices. Implementations of the described techniques may include hardware, a method or process, or a computer tangible medium.

In one general aspect, the method may include generating radio frequency (RF) pulses. The method may also include continuously monitoring a serving channel and a backoff counter by the at least one to determine clear channel conditions. The method may furthermore include triggering transmission frames when the backoff counter reaches zero. The method may, in addition, include transmitting data from one or more ambient IoT devices to at least one ambient-B device over a serving RF channel.

Implementations may include one or more of the following features. The method is performed by an ambient-B device deployed in the network, where the ambient-B device at least energizes a plurality of IoT devices deployed in the network. Implementations of the techniques described may include hardware, a method or process, or a computer tangible medium.

Other embodiments of this aspect include corresponding computer systems, devices, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosure will be apparent from the following detailed description taken in conjunction with the accompanying drawings.

In the drawings:

FIG. 1 shows a timeline diagram of the energy states in an ambient-device's operation;

FIGS. 2A to 2C display timeline diagrams of the triggering mechanisms for energy transfer and communication processes, in accordance with some disclosed embodiments;

FIGS. 3A to 3C illustrate the stages of network management for IoT device communications, in accordance with some disclosed embodiments;

FIG. 4 shows a flowchart diagram of a method for operating a network of ambient (IoT) devices, in accordance with some of the disclosed embodiments;

FIG. 5 illustrates an ambient IoT network, in accordance with some of the disclosed embodiments.

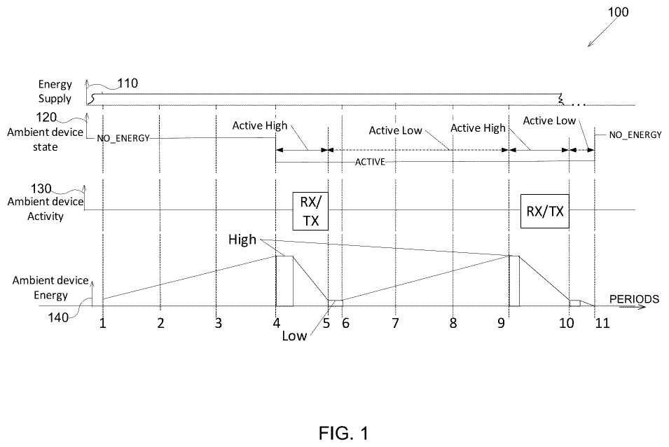

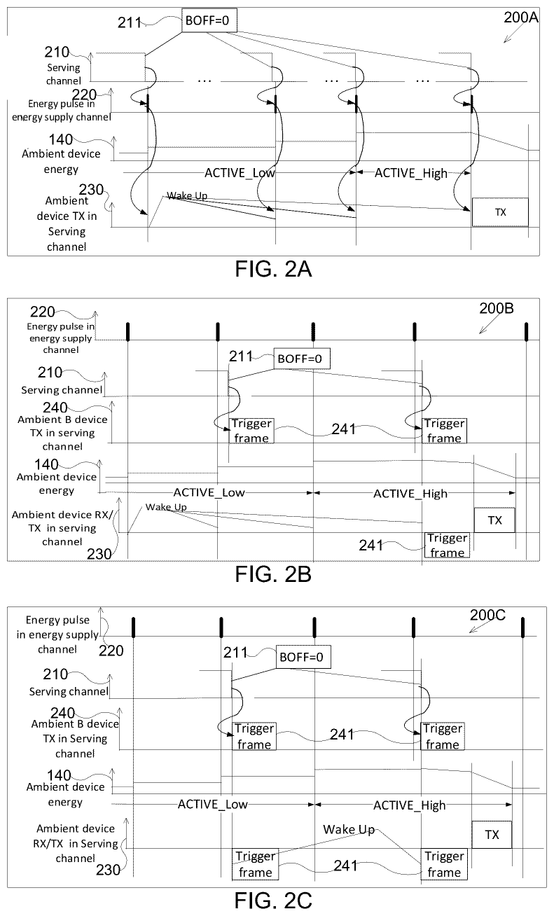

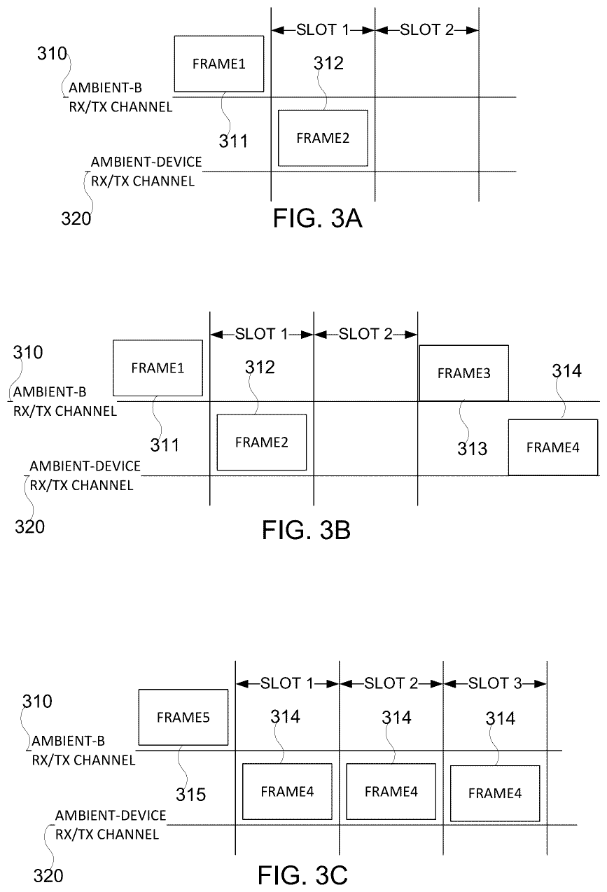

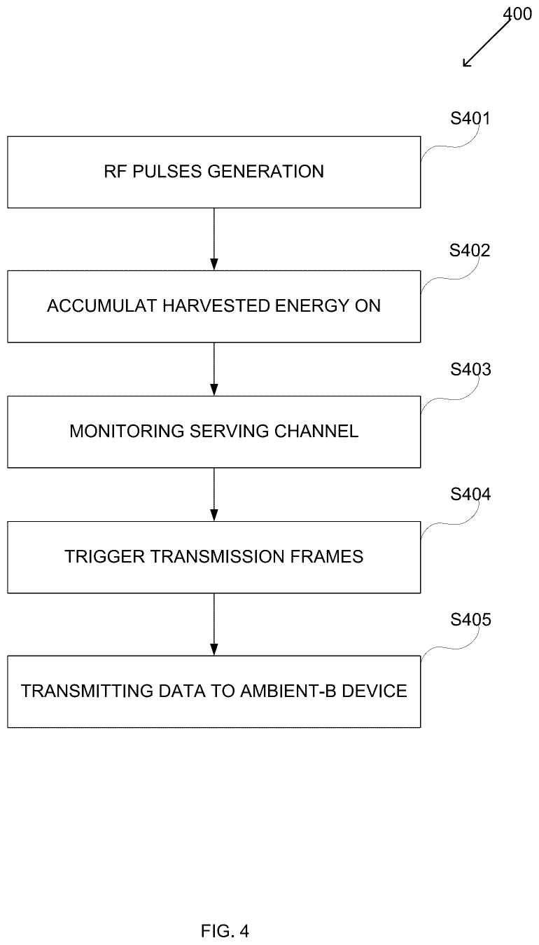

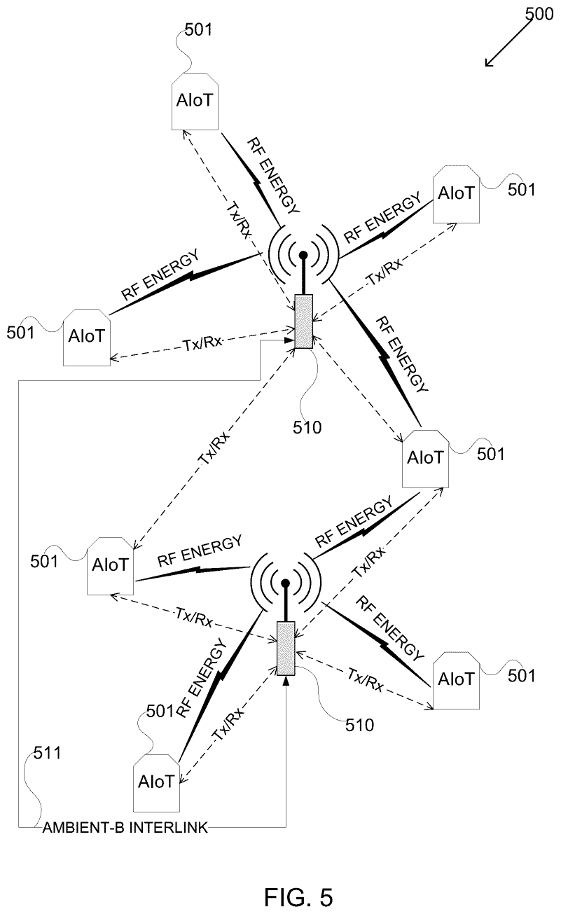

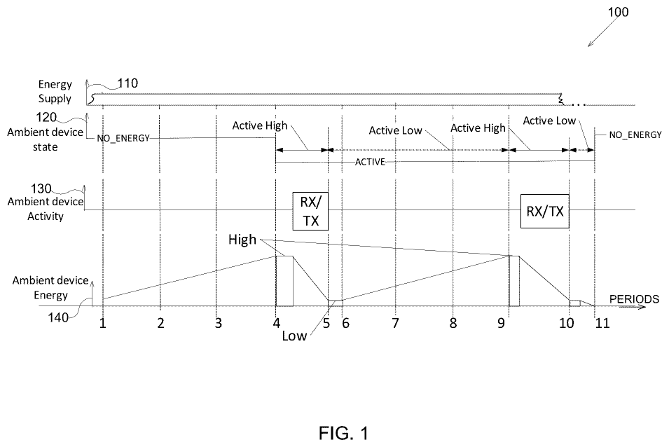

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The technical problem dealt with by the disclosed subject matter relates to the unique operational requirements of ambient IoT devices, which are significantly different from those of most existing IoT devices in the market. This challenge specifically concerns devices engineered to collect and store RF signal energy for subsequent use in receiving and transmitting data (RX/TX).

A primary issue arises due to the limited amount of RF energy that can be effectively harvested and retained by an ambient-device. This limitation poses significant difficulties in ensuring consistent operational efficiency and reliability, particularly in environments where RF energy availability may fluctuate.

Moreover, maintaining the ambient-device in a low-power state to conserve energy complicates compliance with the Listen Before Talk (LBT) protocols mandated by the 802.11 standard. These protocols require devices to verify the absence of conflicting transmissions on the channel before initiating communication, a task that becomes challenging when the device operates primarily in energy-saving modes. This constraint necessitates a careful balance between energy conservation and adherence to communication standards to prevent transmission conflicts and ensure efficient network function.

The present disclosure provides multiple technical solutions aimed at addressing link access issues and optimizing the utilization of accumulated energy for ambient IoT systems. These solutions are designed to improve operational efficiency across various network configurations. In some embodiments, the solution involves either an ambient-B or another device that transmits energy pulses. The ambient-device captures these pulses to store energy, which is subsequently used for transmission and reception (TX/RX) activities.

It should be appreciated that the disclosed technical solutions are engineered to accommodate various operational needs and constraints within IoT networks, with a focus on harmonizing energy efficiency with operational flexibility. This balance is crucial for optimizing the performance of ambient-devices, enhancing their functionality and reliability in diverse network environments.

In some embodiments, ambient-B may be a device that generates and transmits RF energy, serving both as an energy source and a network control unit. It can broadcast energy pulses that are harvested by ambient-devices, enabling them to power their operations, including data transmission and reception. It is important to note that ambient-B plays a crucial role in maintaining the efficiency and functionality of the network by providing the necessary power for other devices. In some embodiments, ambient-B may be engaged in network management duties such as enforcing communication protocols and channel access rules. These duties involve managing compliance with standards such as LBT, which is used to prevent signal interference. Ambient-B may also function as a triggering mechanism, signaling ambient-devices to wake up for tasks or enter a low-power state to conserve energy, thereby optimizing network performance and energy use.

Additionally, or alternatively, the solutions provided by the present disclosure may include a mechanism where ambient-B assumes the responsibility of enforcing channel access rules, consequently facilitating the ambient-device's ability to respond to transmission triggers without managing LBT compliance itself. By shifting the burden of LBT compliance to ambient-B, the ambient-device can focus on efficient energy use and effective communication, thus alleviating issues related to channel access conflicts and enhancing overall network performance.

One technical solution provided by the present disclosure involves the activation and data transmission operations of the ambient-device being triggered by an energy pulse emitted by ambient-B. This ambient-B also complies with the regulations of the relevant frequency band during the transmission of this energy pulse. It should be noted that no specific temporal relationship is required between the energy pulse and the triggering event, as they occur simultaneously. In some embodiments, this configuration enhances energy efficiency, as the ambient-device does not expend energy idly waiting between the receipt of the energy pulse and the initiation of data transmission. The operation is fully synchronized, thereby maximizing energy conservation.

Another technical solution provided by the present disclosure introduces a temporal delay between the reception of energy and the commencement of data transmission. In this embodiment, the ambient-device is activated by an energy pulse but delays transmission until it receives a separate trigger frame. Ambient-B adheres to established transmission protocols when dispatching both the energy pulse and the trigger frame, with precise timing between these two events being critical to ensure synchronization. This arrangement reduces energy wastage by aligning the receipt of energy with transmission opportunities, thereby ensuring that the ambient-device possesses adequate power when required and remains compliant with transmission protocols.

It should be understood that in the context of IoT communications, a “frame” refers to a structured unit of data exchanged between devices, including control information, addresses, and data payload. Frames facilitate network tasks such as device discovery, ID assignment, and compliance with communication protocols, ensuring efficient and orderly data transmission within the network.

A further technical solution provided by the present disclosure manages all operational activities of the ambient-device, including activation, data transmission initiation, and the transmission actions of ambient-B through the timing of a trigger frame. In some embodiments, this configuration eliminates dependency on the timing of the energy pulse for initiating transmission activities, providing operational flexibility but requiring that the ambient-device possess coarse sensitivity to fluctuations in energy levels to maintain operational readiness without unnecessary energy consumption. This approach facilitates more strategic use of energy but demands meticulous management of the trigger frame timing to optimize energy utilization and ensure robust communication.

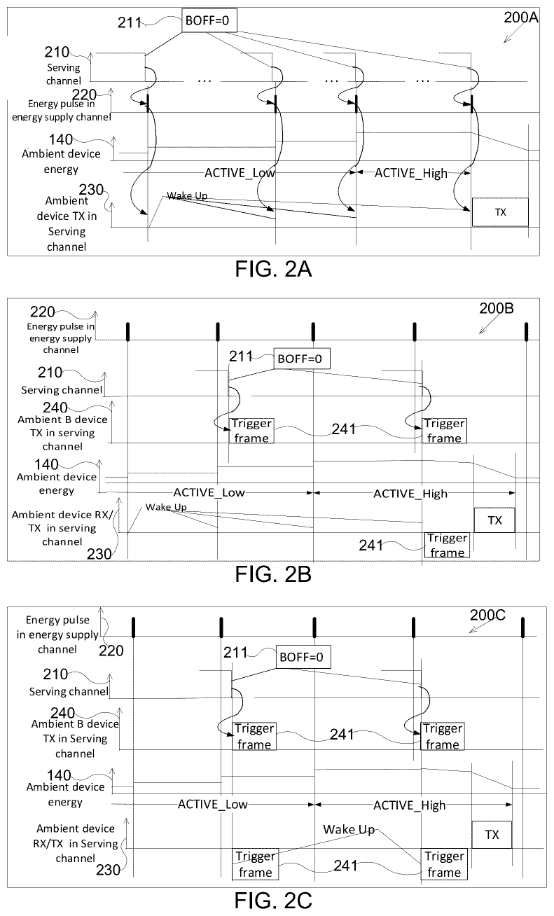

FIGS. 2A to 2C show timeline diagrams of the triggering mechanisms for energy transfer and communication processes, in accordance with some disclosed embodiments.

FIG. 2A illustrates one embodiment shown in timeline diagram 200A. In this embodiment, ambient-B periodically generates pulses in the frequency band below 1 GHz, which the ambient-device uses to store energy as depicted by serving channel 210 and energy pulses by energy supply channel 220. Once the energy accumulated within the ambient-device, from pulses received from ambient-B, reaches a sufficient threshold for transmission (as depicted by Ambient-Device Energy 140), it wakes up and transmits (TX) a frame to ambient-B over an ambient-device TX in serving channel 230, such as 2.4 GHz or another channel in the licensed spectrum below 1 GHz.

Due to its limited receiver capabilities, the ambient-device cannot independently comply with the LBT rule required for transmission within Industrial, Scientific, and Medical (ISM) radio frequency bands. In this exemplary embodiment, to facilitate compliance with this rule, ambient-B actively monitors the serving channel, such as the 2.4 GHz band, and initiates the transmission of an energy pulse 220 only when its backoff counter reaches zero (BOFF=0) 211, indicating that transmission is permissible. Consequently, when the ambient-device transmits concurrently with the arrival of an energy pulse, it adheres to the LBT rule. It is important to note that this method is also effective when the energy pulses are transmitted on the same frequency band that the ambient-device uses for its transmissions. This strategy ensures that the ambient-device remains compliant with regulatory standards while efficiently utilizing the energy managed by ambient-B.

It should be noted that in network communications, particularly under protocols like IEEE 802.11, devices use a backoff counter as part of the Listen Before Talk (LBT) strategy to manage access to a shared channel. Before transmitting, a device checks if the channel is free. If it is occupied, the device waits, counting down from a randomly set backoff counter. The device only transmits when the counter reaches zero and the channel is clear, minimizing data collisions and ensuring orderly communication.

FIG. 2B illustrates another embodiment shown in timeline diagram 200B. In this embodiment, ambient-B periodically generates pulses within the frequency range below 1 GHz, which the ambient-device uses to store energy, as depicted by serving channel 210 and energy pulses by energy supply channel 220. Ambient-B monitors the serving channel 210 and transmits a trigger frame 241 (as depicted by ambient-B TX in serving channel 240) only after the BOFF 211 reaches zero, following the transmission of the energy pulse 220.

Upon receiving the energy pulse 220, and once the energy accumulated in the ambient-device reaches a threshold sufficient for transmission, the ambient-device wakes up, activates its receiver on the serving channel 210, and keeps the receiver active for a predetermined period or until it receives a trigger frame 241. In some embodiments, the trigger frame 241, transmitted by ambient-B, initiates a transmission opportunity, during which the ambient-device transmits its frame, adhering to the 2.4 GHz link access rules as depicted by ambient-device RX/TX in serving channel 230.

It should be noted that this embodiment can also be effective when both the energy pulse 220 and the trigger frame 241 are transmitted over the same serving channel frequency band, even if that band is below 1 GHz. This setup ensures that the ambient-device utilizes energy efficiently while remaining compliant with regulatory transmission standards.

FIG. 2C illustrates yet another embodiment as shown in timeline diagram 200C. In this embodiment, ambient-B periodically generates pulses within the frequency range below 1 GHz, which the ambient-device uses to store energy, as depicted by serving channel 210 and energy pulses by energy supply channel 220. Ambient-B monitors the serving channel 210 and transmits a trigger frame 241 (as depicted by ambient-B TX in serving channel 240) only after the BOFF 211 reaches zero, independent of the timing of the energy pulses 220. This setup allows for the possibility that energy pulses could be sent by a station other than ambient-B due to the independence of trigger frames 241 from energy pulses 220.

In some embodiments, when the ambient-device energy 140 is in the active-low state, the ambient-device can wake up upon receiving a trigger frame 241. This operation requires the trigger frame 241 to have high reception (RX) power at the ambient-device RX/TX in serving channel 230, which typically occurs when the ambient-device is in close proximity to ambient-B.

Once the ambient-device energy 140 reaches a level sufficient for transmission, i.e., the active-high state, and it receives a trigger frame 241, the ambient-device can then transmit a frame back to ambient-B over ambient-device RX/TX in serving channel 230. It should be noted that the trigger frame 241 from ambient-B initiates a transmission opportunity, during which the ambient-device transmits its frame in compliance with the 2.4 GHz channel access rules.

It will be appreciated that this embodiment can also be effective even when the energy pulses and the trigger frame are transmitted over the same frequency band. Such an arrangement ensures efficient use of energy while maintaining compliance with regulatory transmission standards.

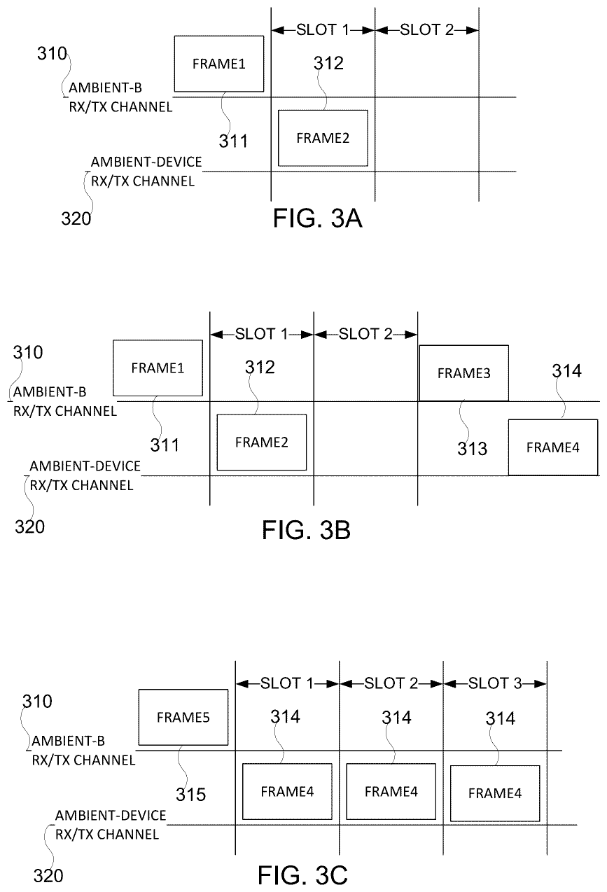

FIGS. 3A to 3C illustrate various stages of network management for IoT device communications, in accordance with some disclosed embodiments.

Specifically, FIGS. 3A to 3C depict operations involving trigger frames based on the timeline diagrams of the triggering mechanisms shown in FIGS. 2A to 2C. It should be noted that the exemplary embodiments illustrated in FIGS. 3A to 3C include, but are not limited to, sequential (timely) processes such as discovery, ID assignment, addressing multiple ambient-devices individually, and combining multiple operations in a single sequence.

FIG. 3A illustrates an exemplary embodiment of a discovery procedure, as depicted in diagram 300A. In this embodiment, the discovery procedure is strategically used to pinpoint the individual address of each ambient-device within the network. Ambient-B emits a trigger frame (Frame1 311A) over its RX/TX channel 310, which specifies the number of time slots of a designated size (Slot 1 and Slot 2, in this example) that follow immediately after the trigger frame. Frame1 311A is broadcasted with a receive address (RA) that enables any ambient-device within range to respond, along with a transmit address (TA) that uniquely identifies the emitting ambient-B. Each ambient-device independently selects a slot to transmit its response (Frame2 312) over its RX/TX channel 320, effectively minimizing potential collisions among responses from multiple ambient-devices. The response frame is specifically directed to ambient-B and includes an RA that corresponds to a particular ambient-B individual address, and a TA of the transmitting ambient-device's address, thus allowing ambient-B to ascertain which ambient-devices to interact with upon completion of the discovery process.

FIG. 3B illustrates an exemplary embodiment of an identification (ID) assignment procedure, as shown in diagram 300B. This procedure, synchronized with the discovery process, employs an identifier significantly shorter than the MAC address to categorize stations under the control of the same controller, such as ambient-B. Each ambient-device is identified not only by this compact identifier but also by the individual address of ambient-B. Once ambient-B has generated the ID, it is transmitted over its RX/TX channel 310 to the ambient-device, which receives the ID via its own RX/TX channel 320, ensuring the ID is properly acknowledged by the intended recipient. Following this, an individually addressed frame (Frame3 313) conveys ID=A to a designated ambient-device, which in response, transmits another individually addressed frame (Frame4 314) back to ambient-B. This frame employs the assigned identifier to clearly specify the sender's transmit address (TA) and may also include control or application-specific information pertinent to network operations. Upon successful discovery of an ambient-device, ambient-B continues with this identifier assignment protocol, integrating it into the ongoing operational sequence to maintain network efficiency and coherence.

FIG. 3C illustrates an exemplary embodiment of addressing multiple ambient- devices, as depicted in diagram 300C. This procedure involves ambient-B transmitting a frame (Frame5 315) over its RX/TX channel 310, which specifies the particular ambient-devices that are to respond. These ambient-devices are identified by their IDs and are programmed to respond in designated time slots following the trigger frame (Frame5 315). In some embodiments, slots 1 to 3 are allocated for responses from the ambient-devices, each broadcasting over their respective RX/TX channel 320, in the order determined by the IDs specified in the trigger frame. For instance, an ambient-device with ID=C responds during slot 1, while those with IDs A and E respond during slots 2 and 3, respectively. This structured response mechanism allows for organized and efficient communication among multiple devices, facilitating effective network management and reducing the likelihood of signal collisions.

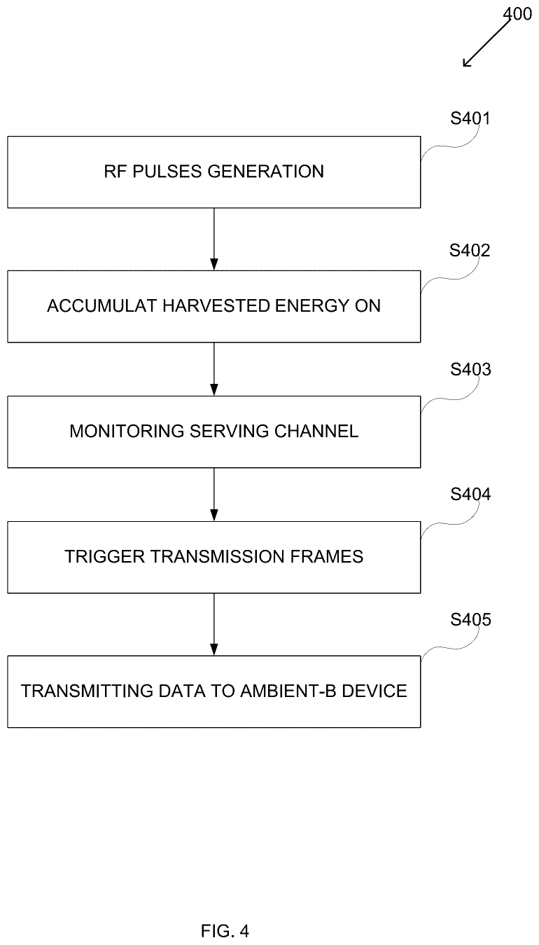

FIG. 4 illustrates a flowchart diagram of a method for operating a network of ambient Internet of Things (IoT) devices, in accordance with disclosed embodiments.

It should be appreciated that each step of the following method outlines a specific aspect used to enable effective communication and energy management among ambient devices within an IoT network. This emphasizes the system's reliance on RF energy harvesting and intelligent network management to operate within technological and regulatory constraints.

At S401, radio frequency (RF) pulses are generated by at least one Ambient-B device. In some embodiments, the Ambient-B may be powered by batteries or other sources, periodically generating RF energy pulses within a frequency band below 1 GHz. These pulses function as the primary energy source for ambient devices, which rely solely on this energy to function. The frequency and regularity of these pulses are critical to ensure the ambient devices can accumulate enough energy to operate.

At S402, energy harvested may be accumulated. In some embodiments, ambient devices harvest energy from the RF pulses generated by the Ambient-B device and it is accumulated at one or more ambient IoT devices. The energy is stored until it reaches a threshold level sufficient for transmission. This accumulation is crucial for enabling the ambient devices, enabling them to maintain operational readiness for subsequent communication tasks. Without this stored energy, the ambient devices would remain in transition from a (non-active) no-energy state to an active high-energy state.

At S403, a serving channel may be continuously monitored. In some embodiments, a serving channel and a backoff counter are continuously monitored by at least one Ambient-B device to determine clear channel conditions. This monitoring ensures that the Ambient-B device can effectively manage the timing for safe and efficient data transmission.

At S404, transmission frames may be triggered. In some embodiments, frames are transmitted by the at least one Ambient-B device when the backoff counter reaches zero also indicating that one or more ambient IoT devices transit from a no-energy state to an active high-energy state in response to the accumulated energy reaching a predetermined threshold level. In some embodiments, this step involves the Ambient-B device issuing a trigger frame to the ambient devices, initiating the communication process under clear channel conditions, and aligning with required channel access protocols.

At S405, data may be transmitted. In some embodiments, the data may be transmitted from the one or more ambient IoT devices to the Ambient-B device over a serving RF channel upon receiving the trigger frame ensures that the transmissions adhere to established frequency band regulations and occur only when legally permissible under LBT rules, thereby preventing potential interference and maintaining compliance with critical communication standards. In some embodiments, the serving RF channel may include options such as a 2.4 GHz band or another licensed spectrum below 1 GHz.

It should be appreciated that the method ensures efficient and compliant network operations by implementing Listen Before Talk (LBT) protocols throughout, which manage the timing of transmissions based on legal permissibility and help avoid potential interference, thus maintaining adherence to critical communication standards.

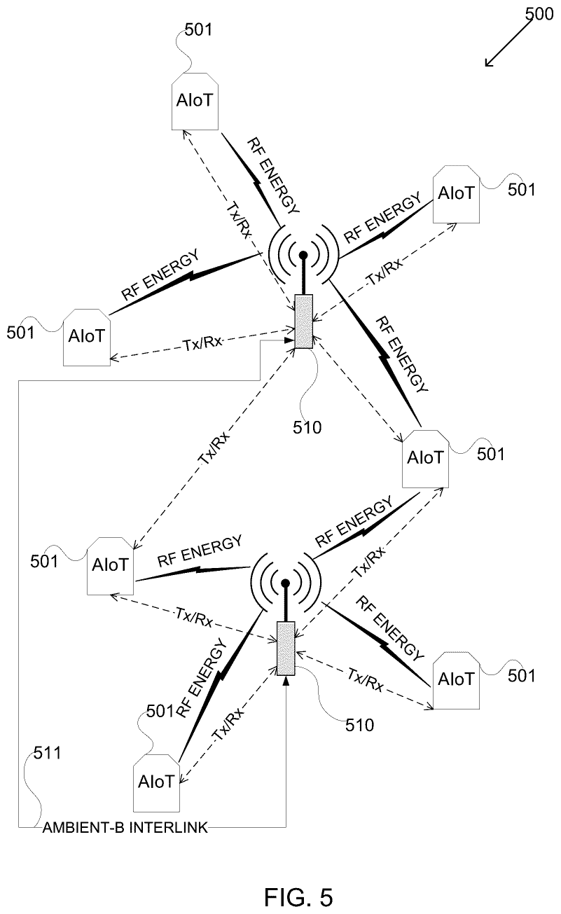

FIG. 5 illustrates an Ambient IoT Network 500 according to some exemplary embodiments of the disclosed subject matter. Ambient IoT Network 500 is designed for interconnectivity using IoT devices that harness ambient energy sources such as RF pulses but is not limited to these. In some embodiments, Network 500 includes two main types of devices: an Ambient-B device (Ambient-B 510) and an ambient IoT device (AIoT 501), each fulfilling critical roles within the network. It should be noted that the terms ‘Ambient IoT device’, ‘AIoT device’, ‘AIoT Tag’, and ‘IoT Tag’ are used interchangeably in this disclosure to refer to the same component.

In some embodiments, Ambient-B 510 devices are connected through Ambient-B Interlink 511, either wirelessly or via wired connections. This configuration enhances network design flexibility, supporting diverse deployment scenarios and adapting to environmental constraints.

In some embodiments, Ambient-B 510 may be used as an energy source within Network 500 and manage transceivers (Tx/Rx) protocols and channel access, ensuring adherence to standards such as IEEE 802.11 and 3GPP (3GPP stands for ‘3rd Generation Partnership Project,’ a collaborative project between groups of telecommunications standards associations). The one or more AIoT 501 devices in the network operate by harvesting the energy transmitted by Ambient-B 510 devices. In some embodiments, AIoT 501 devices incorporate sensors or actuators to perform tasks such as environmental monitoring, health metric tracking, smart home appliance control, or similar applications without external power sources. They manage their energy to maintain functionality, transitioning between no-energy, active-high, and active-low states depending on their accumulated harvested power.

The Ambient-B 510 devices are tasked with generating and transmitting RF energy vital for powering AIoT 501 devices, which depend on the energy from Ambient-B 510 as they lack traditional power sources. In addition to energy transmission, Ambient-B 510 is designed to execute communication protocols and optimize energy use among AIoT 501 devices. It adheres to ‘Listen Before Talk’ (LBT) protocols and other channel access rules to prevent data collisions and ensure efficient network operation. In some embodiments, Ambient-B 510 devices also facilitate network 500 communication (Tx/Rx), acting as relay points that forward data from AIoT 501 devices to broader networks through various channels such as wireless LAN, 3GPP core networks, Bluetooth, and other links defined by the Ambient IoT Alliance. Furthermore, Ambient-B 510 may be an advanced IoT gateway that emits RF pulses to support an ambient IoT setup. For example, Ambient-B 510 could be a wireless power transmitter designed for long-range wireless charging, capable of powering AIoT 501 devices over the air up to 80 feet away. It should be noted that Ambient-B 510 also includes communication capabilities adhering to IEEE 802.11 (Wi-Fi), 3GPP, Bluetooth Low Energy (LE), or any combination thereof.

In some exemplary embodiments, the controller (not shown), supported by a semiconductor memory, may be a Central Processing Unit (CPU), a microprocessor, an electronic circuit, or an Integrated Circuit (IC). Additionally, or alternatively, the controller (not shown) can be implemented as firmware written for or ported to a specific processor, such as a Digital Signal Processor (DSP), a Field Programmable Gate Array (FPGA), or an Application Specific Integrated Circuit (ASIC). In some embodiments, the controller (not shown) may be utilized to perform computations required by Ambient-B 510 or any of its subcomponents for executing methods as depicted in FIG. 4 and stages of network 500 management depicted in FIGS. 3A to 3C.

In some exemplary embodiments, the controller (not shown) utilizes the transceiver (not shown) to communicate with AIoT 501 devices and other Ambient-B 510 devices in Network 500, using IEEE 802.11, 3GPP, Bluetooth Low Energy (LE), or any combination thereof. In some embodiments, the transceiver (not shown) may also be used to transmit RF energy pulses to AIoT 501 devices within network 500. Additionally, or alternatively, the controller (not shown) employs the transceiver (not shown), coupled with an antenna, to transmit information to other network elements (not shown), such as a router, a switch, a gateway, or any communication device that supports BLE protocol communication.

AIoT 501 devices are designed to function autonomously by harvesting RF signal energy. They do not have internal power sources, relying entirely on energy harvested from their environment, primarily provided by Ambient-B 510 devices, although not exclusively. In some embodiments, AIoT 501 devices operate in various states: dormant (no-energy), operational peak (active-high) for data transmission, and energy conservation post-operation (active-low). AIoT 501 devices may be utilized within Network 500 and are suitable for applications requiring low-power, wireless communication capabilities, such as RFID tags, wireless sensor nodes, smart home devices, and health monitors, among others. AIoT 501 devices convert ambient energy into usable power.

AIoT 501 includes an accumulator (not shown) used to store electrical energy for the operation of AIoT 501. In some exemplary embodiments, the accumulator (not shown) may be an on-die capacitor, an external capacitor, or both. Additionally, or alternatively, the accumulator (not shown) may include at least one rechargeable battery. It should be noted that capacitors store electrical energy harvested from RF pulses as electrical charge accumulates on their plates.

The various embodiments disclosed herein can be implemented as hardware, firmware, software, or any combination thereof. Moreover, the software is preferably implemented as an application program tangibly embodied on a program storage unit or computer-readable medium consisting of parts, or certain devices and/or a combination of devices. The application program may be uploaded to, and executed by, a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to further the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for operating a network of ambient Internet of Things (IoT) devices, comprising:
generating radio frequency (RF) pulses by at least one ambient-B device;
accumulating energy harvested from the RF pulses at one or more ambient IoT devices, wherein the one or more ambient IoT devices transition from a no-energy state to an active high-energy state upon reaching a sufficient level of accumulated energy;
continuously monitoring a serving channel and a backoff counter by the at least one ambient-B device to determine clear channel conditions;
triggering transmission frames by the at least one ambient-B device when the backoff counter reaches zero; and
transmitting data from one or more ambient IoT devices to the at least one ambient-B device over a serving RF channel, wherein monitoring and controlled triggering enhance network efficiency and compliance with communication protocols.

2. The method of claim 1, wherein the radio frequency (RF) pulses are generated within a frequency band below 1 GHz.

3. The method of claim 1, wherein the energy harvested from the RF is stored until the energy harvested reaches a threshold level sufficient for enabling any one of: transmission a signal, and a reception of a signal, thereby ensuring the ambient IoT devices maintain operational readiness for communication tasks.

4. The method of claim 1, wherein the ambient IoT devices accumulate energy from the RF pulses until a sufficient level is reached to transition from a no-energy state to an active high-energy state, thereby managing the timing of their operational readiness based on energy availability.

5. The method of claim 1, wherein at least one ambient-B device continuously monitors the serving channel and the backoff counter to determine clear channel conditions before triggering transmission frames.

6. The method of claim 1, wherein the transmission frames are triggered by the at least one ambient-B device only when the backoff counter reaches zero, indicating clear channel conditions for safe transmissions.

7. The method of claim 1, wherein the data transmitted from the one or more ambient IoT devices to the at least one ambient-B device over the serving RF channel is used for maintaining a communication process within the network.

8. The method of claim 1, further comprising: operating by the ambient-B device a Listen Before Talk (LBT) protocol to ensure transmissions occur only when permissible, thereby maintaining adherence to critical communication standards and avoiding potential interference.

9. The method of claim 1, wherein data transmission from the ambient IoT devices to the ambient-B device occurs over a serving RF channel that includes one of a 2.4 GHz band or another spectrum below 1 GHz, ensuring compliant and effective communication.

10. The method of claim 1, wherein the ambient-B device monitors the success of the transmission and adapts energy pulse and transmission frame issuance based on feedback from the ambient IoT devices to improve network reliability and efficiency.

11. The method of claim 1, wherein the transmission frames from at least one ambient-B device and the one or more ambient IoT devices are configured to communicate over a Wi-Fi network.

12. The method of claim 1, wherein the transmission frames from at least one ambient-B device and the one or more ambient IoT devices are configured to operate within the Third Generation Partnership Project (3GPP) network, adhering to 3GPP communication protocols.

13. The method of claim 1, wherein the transmission frames from at least one ambient-B device and the one or more ambient IoT devices are configured to operate over Bluetooth technologies for communication.

14. The method of claim 1, wherein the at least one ambient-B device transmits a trigger frame after verifying clear channel access and determining that a sufficient level of energy has been accumulated in the one or more ambient IoT devices.

15. A method for operating a network of ambient Internet of Things (IoT) devices, comprising:
generating radio frequency (RF) pulses;
continuously monitoring a serving channel and a backoff counter by the at least one to determine clear channel conditions;
triggering transmission frames when the backoff counter reaches zero; and
transmitting data from one or more ambient IoT devices to the at least one ambient-B device over a serving RF channel.

16. The method of claim 15, wherein the method is performed by an ambient-B device deployed in the network, wherein the ambient-B device at least energizes a plurality of IoT devices deployed in the network.

17. A non-transitory computer-readable medium storing a set of instructions for operating an ambient-B device to perform the method of claim 15.

18. An ambient device deployed in an ambient Internet of Things (IoT) network, comprising:
a controller coupled with a memory; and
a transceiver coupled with an antenna to wirelessly communicate over the network, wherein the memory is configured to store instructions that, when executed by the controller configured the device to:
generate radio frequency (RF) pulses by at least one ambient-B device;
continuously monitor a serving channel and a backoff counter by the at least one ambient-B device to determine clear channel conditions;
trigger transmission frames by the at least one ambient-B device when the backoff counter reaches zero; and
transmit data from one or more ambient IoT devices to the at least one ambient-B device over a serving RF channel; wherein monitoring and controlled triggering enhance network efficiency and compliance with communication protocols.
